(19) United States
(12) Patent Application Publication
(10) Pub. No.: US 2016/0043396 A1
(43) Pub. Date: Feb. 11, 2016

(54) CATHODE ACTIVE MATERIAL

(71) Applicant: ASAHI GLASS COMPANY, LIMITED, Tokyo (JP)

(72) Inventors: Tomohiro SAKAI, Tokyo (JP); Sadatatsu Ikeda, Tokyo (JP); Tsubasa Takasugi, Tokyo (JP); Takuya Teratani, Tokyo (JP)

(73) Assignee: ASAHI GLASS COMPANY, LIMITED, Tokyo (JP)

(21) Appl. No.: 14/918,638

(22) Filed: Oct. 21, 2015

Related U.S. Application Data
(63) Continuation of application No. PCT/JP2014/064000, filed on May 27, 2014.

(30) Foreign Application Priority Data
May 28, 2013 (JP) 2013-112126

(51) Int. Cl. H01M 4/505; H01M 4/525

(52) U.S. Cl. CPC H01M 4/505; H01M 4/525; H01M 2004/028

(57) ABSTRACT

To provide a cathode active material to be used for a positive electrode of a lithium ion secondary battery having a high discharge capacity and favorable cycle durability.

A cathode active material, which comprises a lithium-containing composite oxide containing at least one transition metal element (X) selected from the group consisting of Ni element, Co element and Mn element, and Li element (provided that the molar ratio (Li/X) of the Li element based on the total amount of the transition metal element (X) is from 1.1 to 1.7),

wherein the aspect ratio of primary particles is from 2.5 to 10, and

in an X-ray diffraction pattern, the ratio (I₀₂₀/I₀₀₃) of the integrated intensity (I₀₂₀) of a peak of (020) plane assigned to a crystal structure with space group C2/m to the integrated intensity (I₀₀₃) of a peak of (003) plane assigned to a crystal structure with space group R-3m is from 0.02 to 0.3.

### TECHNICAL FIELD

The present invention relates to a cathode active material to be used for a positive electrode of a lithium ion secondary battery having a high discharge capacity and favorable cycle durability.

### BACKGROUND ART

Lithium ion secondary batteries have been widely used for e.g. portable electronic instruments such as mobile phones and notebook personal computers. As a lithium ion secondary battery, for example, one using LiCoO₂ as a cathode active material and a lithium alloy, graphite, carbon fiber or the like as a negative electrode, has been known. Such a lithium ion secondary battery has a high energy density, however, it has a problem in that its cost is increased since Co element is expensive.

Thus, at present, a cathode active material using Ni element, Co element and Mn element as an alternative to Co element to reduce the amount of use of Co element, a cathode active material which is a solid solution of a crystal structure with space group R-3m and a crystal structure with space group C2/m, having a high content of Li element and Mn element (hereinafter sometimes referred to as lithium/manganese rich) and the like have been proposed. However, such cathode active materials have low property to maintain the capacity after a charge and discharge cycle is repeatedly carried out (hereinafter sometimes referred to as cycle durability in this specification). Accordingly, it has been desired to propose a cathode active material having cycle durability suitable for practical use.

For a lithium ion secondary battery for portable electronic instruments or for vehicles, downsizing and weight saving are required. Accordingly, a cathode active material having a high discharge capacity per unit mass (hereinafter referred to simply as discharge capacity) has been desired. The lithium/manganese rich cathode active material is known to have a high discharge capacity.

Patent Document 1 proposes, as a cathode active material having favorable cycle durability, for example, a cathode active material comprising secondary particles having primary particles having an aspect ratio of at least 2.0 and at most 10.0 agglomerated, wherein in powder X-ray diffraction measurement using CuKα rays, 0.10°≦FWHM110≦0.30° is satisfied, where FWHM110 is the full width at half maximum of a 110 diffraction peak present within a range of diffraction angle 2θ of 64.5°±1.0°. However, since this cathode active material is not a lithium/manganese rich cathode active material, its discharge capacity is not sufficiently high.

### PRIOR ART DOCUMENTS

### Patent Documents

Patent Document 1: WO2012/124240

### DISCLOSURE OF INVENTION

### Technical Problem

The object of the present invention is to provide a cathode active material to be used for a positive electrode of a lithium ion secondary battery having a high discharge capacity and favorable cycle durability.

### Solution to Problem

To achieve the above object, the present inventors have conducted extensive studies and as a result, found that the cycle durability of a lithium ion secondary battery can be improved by using a lithium/manganese rich cathode active material having an increased structural stability of primary particles.

That is, the present invention provides the following.

[1] A cathode active material, which comprises a lithium-containing composite oxide containing at least one transition metal element selected from the group consisting of Ni element, Co element and Mn element (hereinafter sometimes referred to simply as “transition metal element (X)”), and Li element (provided that the molar ratio (Li/X) of the Li element based on the total amount of the transition metal element (X) is from 1.1 to 1.7),

wherein the aspect ratio of primary particles is from 2.5 to 10, and

in an X-ray diffraction pattern, the ratio (I₀₂₀/I₀₀₃) of the integrated intensity (I₀₂₀) of a peak of (020) plane assigned to a crystal structure with space group C2/m to the integrated intensity (I₀₀₃) of a peak of (003) plane assigned to a crystal structure with space group R-3m is from 0.02 to 0.3.

[2] The cathode active material according to the above [1], which is a solid-solution of Li_{4/3}Mn_{2/3}O₂ and LiMO₂ (wherein M is at least one transition metal element selected from the group consisting of Ni element, Co element and Mn element).
[3] The cathode active material according to the above [2], wherein the solid-solution is represented by the following formula (1):

aLi_{4/3}Mn_{2/3}O₂.(1−a)LiMO₂ (1)

wherein M is at least one transition metal element selected from the group consisting of Ni element, Co element and Mn element, and “a” is from 0.1 to 0.78.

[4] The cathode active material according to any one of the above [1] to [3], wherein the molar proportion of Ni element is from 15 to 50%, the molar proportion of Co element is from 0 to 33.3%, and the molar proportion of Mn element is from 33.3 to 85% based on the total amount of the at least one transition metal element (X) selected from the group consisting of Ni element, Co element and Mn element.
[5] The cathode active material according to the above [2], wherein the solid-solution is represented by the following formula (2):

aLi_{4/3}Mn_{2/3}O₂.(1−a)LiNi_{α}Co_{β}Mn_{γ}O₂ (2)

wherein α is from 0.33 to 0.55, β is from 0 to 0.33, and γ is from 0.30 to 0.5, provided that α+β+γ=1, and “a” is from 0.1 to 0.78.

[6] The cathode active material according to any one of the above [1] to [5], wherein the cathode active material has a particle size D₅₀ of 3 to 15 μm.
[7] The cathode active material according to any one of the above [1] to [6], wherein the cathode active material has a ratio D₉₀/D₁₀ of the particle size D₉₀ to the particle size D₁₀ of 1 to 2.6.
[8] The cathode active material according to any one of the above [1] to [7], wherein the cathode active material has a specific surface area of 0.1 to 10 m²/g.
[9] The cathode active material according to any one of the above [1] to [8], wherein primary particles have an average value of the equivalent circle diameter of 10 to 1,000 nm.
[10] The cathode active material according to any one of the above [1] to [8], wherein primary particles have an average value of the equivalent circle diameter of 200 to 700 nm.

### Advantageous Effects of Invention

According to the cathode active material of the present invention, the discharge capacity of a lithium ion secondary battery can be increased, and the cycle durability can be improved.

### BRIEF DESCRIPTION OF DRAWINGS

FIG. 1 is a drawing illustrating an example in which the respective primary particles to calculate the aspect ratio are edged in a SEM image.

FIG. 2 is a drawing illustrating definition of d1 and d2 of a primary particle.

FIG. 3 is a graph illustrating X-ray diffraction patterns of the cathode active materials in Ex. 1 and 16.

FIG. 4 is a SEM image of the cathode active material in Ex. 1.

FIG. 5 is a SEM image of the cathode active material in Ex. 13.

FIG. 6 is a TEM image of the cross section of the cathode active material in Ex. 1.

FIG. 7 is a drawing illustrating a comparison between an electron diffraction pattern of a substantially circular primary particle indicated by the arrow in FIG. 6 and simulation of an electron diffraction pattern resulting from [001] incidence in a crystal structure with space group R-3m.

FIG. 8 is a drawing illustrating a comparison between an electron diffraction pattern of a substantially circular primary particle indicated by the arrow in FIG. 6 and simulation of an electron diffraction pattern resulting from [001] incidence in a crystal structure with space group C2/m.

### DESCRIPTION OF EMBODIMENTS

In this specification, “Li” means Li element, not a metal. The same applies to other descriptions such as Ni, Co and Mn. Further, the proportion of element in a lithium-containing composite oxide as described hereinafter is a value in a cathode active material before initial charge (also called activation treatment).

### [Cathode Active Material]

The cathode active material of the present invention comprises a lithium-containing composite oxide containing Li and at least one transition metal element (X) selected from the group consisting of Ni, Co and Mn.

In the cathode active material of the present invention, the molar ratio (Li/X) of Li based on the total content of the transition metal element (X) is from 1.1 to 1.7. Li/X is preferably from 1.1 to 1.67, particularly preferably from 1.25 to 1.6. When Li/X is within the above range, a high discharge capacity will be obtained.

The cathode active material of the present invention comprises primary particles having an aspect ratio of from 2.5 to 10 agglomerated. The aspect ratio of primary particles is preferably from 2.5 to 8, more preferably from 2.5 to 5. When the aspect ratio of primary particles is within the above range, the crystal structure of the cathode active material is stabilized, and damages to the crystal structure by absorption and desorption of Li by charge and discharge can be reduced. As a result, by use of such a cathode active material, the cycle durability of a lithium ion secondary battery can be improved. In this specification, primary particles are minimum particles observed by a scanning electron microscope (SEM). Further, other agglomerated particles are referred to as secondary particles.

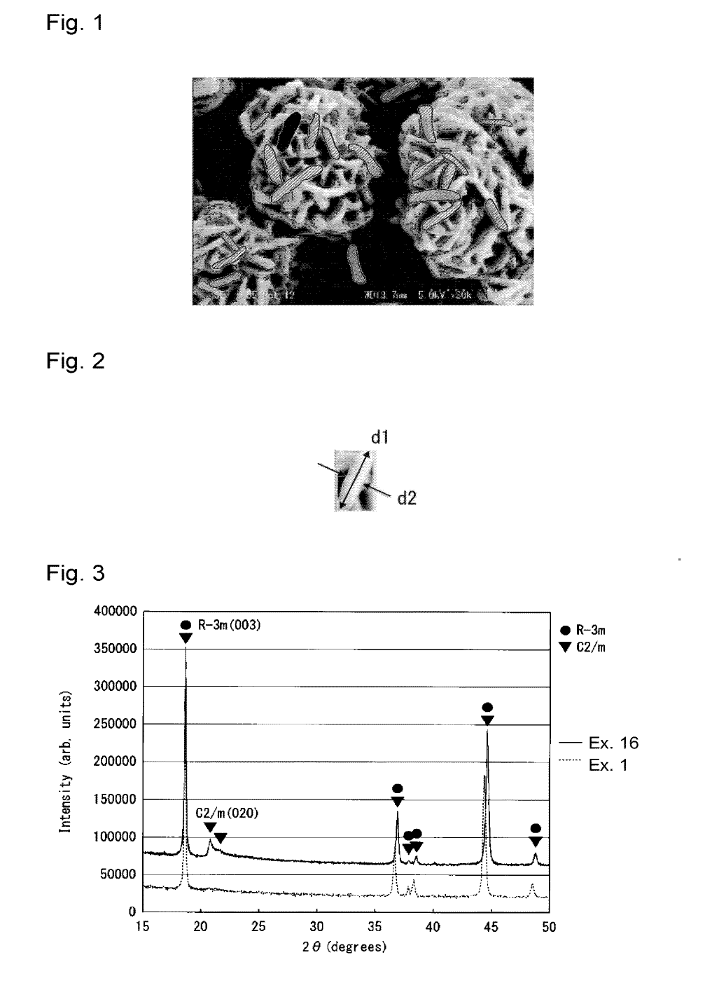

In this specification, the aspect ratio is a value calculated as follows. An image of the cathode active material observed with a scanning electron microscope (SEM) is used. On that occasion, the cathode active material is observed with such a magnification that 100 to 150 primary particles are contained in one SEM image. In the SEM image, the ratio (d1/d2) of the longest size d1 of a primary particle to the maximum size d2 in a direction perpendicular to a direction along the longest size of the primary particle is measured. Such measurement is conducted with respect to totally 100 primary particles, and their average is taken as the aspect ratio. d1 and d2 are defined, for example, as shown in FIGS. 1 and 2.

The cathode active material of the present invention has a crystal structure with space group R-3m and a crystal structure with space group C2/m. The cathode active material having such crystal structures is confirmed by X-ray diffraction measurement. The crystal structure with space group C2/m is assigned to a compound having a transition metal layer containing Li, and is also called lithium excess phase. By using a cathode active material having lithium excess phase, the discharge capacity of a lithium ion secondary battery can be increased.

Further, the cathode active material of the present invention has, in an X-ray diffraction pattern, a ratio (I₀₂₀/I₀₀₃) of the integrated intensity (I₀₂₀) of a peak of (020) plane assigned to the crystal structure with space group C2/m to the integrated intensity (I₀₀₃) of a peak of (003) plane assigned to the crystal structure with space group R-3m of from 0.02 to 0.3. The cathode active material having I₀₂₀/I₀₀₃ within the above range is a lithium/manganese rich cathode active material having the above two crystal structures in well balanced manner. Accordingly, the discharge capacity of a lithium ion secondary battery using such a cathode active material is high. I₀₂₀/I₀₀₃ is preferably from 0.02 to 0.28, more preferably from 0.02 to 0.25.

X-ray diffraction measurement may be carried out by the method disclosed in Examples. The peak of (003) plane assigned to the crystal structure with space group R-3m is a peak which appears at 2θ=18 to 19°. The peak of (020) plane assigned to the crystal structure with space group C2/m is a peak which appears at 2θ=21 to 22°.

The cathode active material of the present invention preferably contains Ni and Mn as the transition metal element (X) with a view to increasing the discharge capacity, and more preferably contains Ni, Co and Mn.

In the cathode active material of the present invention, the contents of Ni, Co and Mn are preferably such that the Ni molar proportion (percentage of Ni/X) is from 15 to 50%, the Co molar proportion (percentage of Co/X) is from 0 to 33.3%, and the Mn molar proportion (percentage of Mn/X) is from 33.3 to 85% based on the content of the transition metal element (X). A lithium ion secondary battery using a cathode active material in which the contents of the transition metal elements are within the above ranges has a high discharge capacity and improved cycle durability.

In the cathode active material of the present invention, the Ni molar proportion is more preferably from 15 to 45%, particularly preferably from 18 to 43%. When the Ni molar proportion is at least 15%, the discharge voltage of a lithium ion secondary battery using such a cathode active material is high. When the Ni molar proportion is at most 45%, the discharge capacity of a lithium ion secondary battery using such a cathode active material is high.

In the cathode active material of the present invention, the Co molar proportion is more preferably from 0 to 30%, particularly preferably from 0 to 25%. When the Co molar proportion is at most 30%, the cycle durability of a lithium ion secondary battery using such a cathode active material is improved.

In the cathode active material of the present invention, the Mn molar proportion is more preferably from 40 to 82%, particularly preferably from 50 to 80%. When the Mn molar proportion is at least 40%, the discharge capacity of a lithium ion secondary battery using such a cathode active material is high. When the Mn molar proportion is at most 82%, the discharge voltage of a lithium ion secondary battery using such a cathode active material is high.

The cathode active material of the present invention is preferably a solid-solution of Li_{4/3}Mn_{2/3}O₂ and LiMO₂ (wherein M is the transition metal element (X)). A solid solution may be considered as a lithium/manganese rich cathode active material having two crystal structures in one cathode active material. Accordingly, the discharge capacity of a lithium ion secondary battery using such a cathode active material is high.

Li_{4/3}Mn_{2/3}O₂ has a layered rock salt crystal structure with space group C2/m. The crystal structure with space group C2/m is a compound having a transition metal layer containing Li, and is also called lithium excess phase. Whereas, LiMO₂ has a layered rock salt crystal structure with space group R-3m.

The solid solution is preferably represented by the following formula (1):

aLi_{4/3}Mn_{2/3}O₂.(1−a)LiMO₂ (1)

wherein M is a transition metal element (X), and “a” is from 0.1 to 0.78.

When “a” is within the above range, the discharge capacity of a battery can be made high. “a” in the formula (1) is preferably from 0.2 to 0.75, more preferably from 0.2 to 0.65 with a view to increasing the discharge capacity.

The solid solution is more preferably represented by the following formula (2):

aLi_{4/3}Mn_{2/3}O₂.(1−a)LiNi_{α}Co_{β}Mn_{γ}O₂ (2)

wherein α is from 0.33 to 0.55, β is from 0 to 0.33, γ is from 0.30 to 0.5, “a” is from 0.1 to 0.78, and α+β+γ=1. α is preferably from 0.33 to 0.5, β is preferably from 0 to 0.33, and γ is preferably from 0.33 to 0.5. “a” in the formula (2) is preferably from 0.2 to 0.75 with a view to increasing the discharge capacity.

The particle size (D₅₀) of the cathode active material of the present invention is preferably from 3 to 15 μm. D₅₀ of the cathode active material is more preferably from 6 to 15 μm, particularly preferably from 6 to 12 μm. When D₅₀ of the cathode active material is within the above range, a high discharge capacity is likely to be obtained.

In this specification, D₅₀ is a particle size at a point of 50% on an accumulative volume distribution curve which is drawn by obtaining the particle size distribution on the volume basis and taking the whole to be 100%. The particle size distribution is obtained from the frequency distribution and an accumulative volume distribution curve measured by means of a laser scattering particle size distribution measuring apparatus. To measure the particle size, the particle size distribution is measured by sufficiently dispersing the powder in an aqueous medium by e.g. ultrasonic treatment. Specifically, measurement may be carried out by the method disclosed in Examples.

D₉₀/D₁₀ of the cathode active material of the present invention is preferably at most 2.6, more preferably at most 2.4, further preferably at most 2.3. When D₉₀/D₁₀ of the cathode active material is at most 2.6, the particle size distribution is narrow, whereby the electrode density can be made high. A high electrode density is preferred, whereby a battery to obtain the same discharge capacity can be made smaller. D₉₀/D₁₀ of the cathode active material is preferably at least 1. Here, D₁₀ and D₉₀ are particle sizes at points of 10% and 90%, respectively, on the accumulative volume distribution curve.

The average value of the equivalent circle diameter of primary particles of the cathode active material of the present invention is preferably from 10 to 1,000 nm. Within such a range, at the time of preparing a lithium ion secondary battery, an electrolytic solution is likely to sufficiently permeate through the cathode active material in the positive electrode. The average value of the equivalent circle diameter of primary particles is more preferably from 150 to 800 nm, particularly preferably from 200 to 700 nm.

The equivalent circle diameter is preferably from 150 to 900 nm, more preferably from 200 to 800 nm. In this specification, the equivalent circle diameter is the diameter of a circle having the same surface area as a projection drawing of a particle assuming that the projection drawing of the particle is a circle. Measurement is carried out in the same manner with respect to other primary particles, and the average of totally 100 measured values is taken as the average value of the equivalent circle diameter. As a projection drawing of a particle, an image observed with a SEM with such a magnification that 100 to 150 primary particles are contained in one SEM image, is used. To measure the equivalent circle diameter, for example, an image analysis particle size distribution software (manufactured by Mountech Co., Ltd., tradename: Mac-View) may be used.

The specific surface area of the cathode active material of the present invention is preferably from 0.1 to 10 m²/g. When the specific surface area of the cathode active material is at least the lower limit value, a high discharge capacity is likely to be obtained. When the specific surface area of the cathode active material is at most the upper limit value, favorable cycle durability tends to be obtained. The specific surface area of the cathode active material is more preferably from 0.5 to 7 m²/g, particularly preferably from 0.5 to 5 m²/g. The specific surface area of the cathode active material may be measured by the method disclosed in Examples.

### (Production Method)

As a method for producing the cathode active material of the present invention, a method of mixing a coprecipitate obtained by coprecipitation method with a lithium compound and firing the mixture. Use of a coprecipitate is preferred, whereby a high discharge capacity is likely to be obtained. The coprecipitation method is preferably alkali coprecipitation method or carbonate coprecipitation method, and is particularly preferably alkali coprecipitation method, whereby excellent cycle durability is likely to be obtained.

The alkali coprecipitation method is a method of continuously adding an aqueous transition metal salt solution containing the transition metal element (X) and a pH adjusting liquid containing a strong alkali to a reaction container and mixing them to precipitate a hydroxide containing the transition metal element (X) while the pH of the reaction solution is kept constant. By the alkali coprecipitation method, the powder density of the obtainable coprecipitate is high, and a cathode active material having a high packing density will be obtained.

The transition metal salt containing the transition metal element (X) may be a nitrate, acetate, chloride salt or sulfate of Ni, Co or Mn. Preferred is a sulfate of Ni, Co or Mn, whereby excellent battery characteristics will be obtained at a relatively low material cost.

The sulfate of Ni may, for example, be nickel(II) sulfate hexahydrate, nickel(II) sulfate heptahydrate or nickel(II) ammonium sulfate hexahydrate.

The sulfate of Co may, for example, be cobalt(II) sulfate heptahydrate or cobalt(II) ammonium sulfate hexahydrate.

The sulfate of Mn may, for example, be manganese(II) sulfate pentahydrate or manganese(II) ammonium sulfate hexahydrate.

The pH of the solution during the reaction in the alkali coprecipitation method is preferably from 10 to 12.

The pH adjusting liquid containing a strong alkali to be added is preferably an aqueous solution containing at least one member selected from the group consisting of sodium hydroxide, potassium hydroxide and lithium hydroxide. Among them, an aqueous sodium hydroxide solution is particularly preferred.

To the reaction solution in the alkali coprecipitation method, an aqueous ammonia solution or an aqueous ammonium sulfate solution may be added to adjust the solubility of the transition metal element (X).

The carbonate coprecipitation method is a method of continuously adding an aqueous transition metal salt solution containing the transition metal element (X) and an aqueous carbonate solution containing an alkali metal to a reaction container and mixing the solutions to precipitate a carbonate containing the transition metal element (X) in the reaction solution. By the carbonate coprecipitation method, the coprecipitate to be obtained is porous and has a large specific surface area, and a cathode active material exhibiting a high discharge capacity will be obtained.

The transition metal salt containing the transition metal element (X) to be used in the carbonate coprecipitation method may be the same transition metal salt as mentioned for the alkali coprecipitation method.

The pH of the solution during the reaction in the carbonate coprecipitation method is preferably from 7 to 9.

The aqueous carbonate solution containing an alkali metal is preferably an aqueous solution containing at least one member selected from the group consisting of sodium carbonate, sodium hydrogen carbonate, potassium carbonate and potassium hydrogen carbonate.

To the reaction solution in the carbonate coprecipitation method, an aqueous ammonia solution or an aqueous ammonium sulfate solution may be added from the same reason as the alkali coprecipitation method.

By controlling the conditions of the coprecipitation method, the aspect ratio of primary particles of the cathode active material can be adjusted to be within a desired range. With respect to the content of the transition metal element, the lower the Mn proportion is, the higher the aspect ratio tends to be. In the reaction for precipitation of a coprecipitate, the lower the reaction temperature is, or the closer to 7 the pH is, the higher the aspect ratio of primary particles tends to be. Further, the aspect ratio of primary particles tends to be high when the reaction for precipitation of a coprecipitate is carried out in a nitrogen atmosphere.

The reaction solution containing a coprecipitate precipitated by the coprecipitation method is preferably subjected to a step of removing the aqueous solution by filtration or centrifugal separation. For filtration or centrifugal separation, a pressure filter, a vacuum filter, a centrifugal classifier, a filter press, a screw press or a rotary dehydrator may, for example, be used.

The obtained coprecipitate is preferably subjected to a washing step to remove impurity ions such as free alkali. As a method of washing the coprecipitate, for example, a method of repeating pressure filtration and dispersion in distilled water may be mentioned. In a case where washing is carried out, washing is preferably repeated until the electrical conductivity of a supernatant liquid when the coprecipitate is dispersed in distilled water becomes at most 50 mS/m, more preferably at most 20 mS/m.

The particle size D₅₀ of the coprecipitate is preferably from 3 to 15 μm. When D₅₀ of the coprecipitate is within the above range, D₅₀ of the cathode active material can be from 3 to 15 μm. D₅₀ of the coprecipitate is more preferably from 6 to 15 μm, particularly preferably from 6 to 12 μm.

The ratio (D₉₀/D₁₀) of the particle size D₉₀ to the particle size D₁₀ of the coprecipitate is preferably at most 3. When D₉₀/D₁₀ of the coprecipitate is at most 3, due to a narrow particle size distribution, a cathode active material having a high electrode density tends to be obtained. D₉₀/D₁₀ of the coprecipitate is preferably at least 1. D₉₀/D₁₀ of the coprecipitate is more preferably at most 2.8, particularly preferably at most 2.5.

The specific surface area of the coprecipitate is preferably from 10 to 300 m²/g. The specific surface area of the coprecipitate is more preferably from 10 to 150 m²/g, particularly preferably from 10 to 50 m²/g. The specific surface area of the coprecipitate is the specific surface area after the coprecipitate is heated at 120° C. for 15 hours. The specific surface area of the coprecipitate reflects the pore structure formed by the precipitation reaction, and when it is within the above range, the specific surface area of the cathode active material is easily controlled, and favorable battery characteristics tend to be obtained.

The lithium compound is not particularly limited so long as a lithium-containing composite oxide is obtained by mixing it with the coprecipitate and firing the mixture. Such a lithium compound is preferably at least one member selected from the group consisting of lithium carbonate, lithium hydroxide and lithium nitrate, more preferably lithium carbonate.

The mixing ratio of the lithium compound to the coprecipitate is a value close to the molar ratio (Li/X) of Li based on the content of the transition metal element (X) in the cathode active material. Accordingly, Li/X is preferably from 1.1 to 1.7, more preferably from 1.1 to 1.67, particularly preferably from 1.25 to 1.6. When Li/X is higher, the aspect ratio of primary particles tends to be high.

As a method of mixing the coprecipitate and the lithium compound, for example, a method of using a rocking mixer, a nauta mixer, a spiral mixer, a cutter mill or a V mixer may be mentioned.

The firing temperature is preferably from 500 to 1,000° C. When the firing temperature is within the above range, a cathode active material having high crystallinity tends to be obtained. The lower the firing temperature within the above range, the higher the aspect ratio of primary particles tends to be. The firing temperature is more preferably from 600 to 1,000° C., particularly preferably from 800 to 950° C.

The firing time is preferably from 4 to 40 hours, more preferably from 4 to 20 hours.

Firing may be carried out by one-step firing at from 500 to 1,000° C., or may be carried out by two-step firing comprising temporary firing at from 400 to 700° C. and then main firing at from 700 to 1,000° C. Two-step firing is preferred, whereby Li tends to be uniformly dispersed in the cathode active material.

In the case of the two-step firing, the temperature for temporary firing is preferably from 400 to 700° C., more preferably from 500 to 650° C. Further, in the case of the two-step firing, the temperature for main firing is preferably from 700 to 1,000° C., more preferably from 800 to 950° C.

The firing apparatus may, for example, be an electric furnace, a continuous firing furnace or a rotary kiln. Firing is preferably carried out in the air, particularly preferably while the air is supplied, whereby the coprecipitate is oxidized during firing.

The rate of supply of the air is preferably from 10 to 200 mL/min, more preferably from 40 to 150 mL/min per 1 L of the internal capacity of the furnace.

By supplying the air during firing, the transition metal element (X) in the coprecipitate is sufficiently oxidized, whereby a cathode active material having high crystallinity and having a desired crystal phase will be obtained.

The method for producing the cathode active material of the present invention is not limited to the above method, and a hydrothermal synthesis method, a sol gel method, a dry mixing method (solid phase method), an ion exchange method or a glass crystallization method may, for example, be employed.

### [Positive Electrode for Lithium Ion Secondary Battery]

The cathode active material of the present invention is suitably used for a positive electrode for a lithium ion secondary battery.

The positive electrode for a lithium ion secondary battery comprises a cathode current collector and a cathode active material layer formed on the cathode current collector. For the positive electrode for a lithium ion secondary battery, a known embodiment may be employed except that the cathode active material of the present invention is employed. As the cathode active material, one or more types of the cathode active material of the present invention may be used, or the cathode active material of the present invention and one or more types of other cathode active material may be used in combination.

The cathode current collector may, for example, be an aluminum foil or a stainless steel foil.

The cathode active material layer is a layer containing the cathode active material of the present invention, an electrically conductive material and a binder. The cathode active material layer may contain another component such as a thickener as the case requires.

The electrically conductive material may, for example, be acetylene black, graphite or carbon black. As the electrically conductive material, one type may be used, or two or more types may be used in combination.

The binder may, for example, be a fluorinated resin (such as polyvinylidene fluoride or polytetrafluoroethylene), a polyolefin (such as polyethylene or polypropylene), a polymer or copolymer having unsaturated bonds (such as a styrene/butadiene rubber, an isoprene rubber or a butadiene rubber), or an acrylate polymer or copolymer (such as an acrylate copolymer or a methacrylate copolymer). As the binder, one type may be used or two or more types may be used in combination.

The thickener may, for example, be carboxymethyl cellulose, methyl cellulose, hydroxymethyl cellulose, ethyl cellulose, polyvinyl alcohol, oxidized starch, phosphorylated starch, casein or polyvinylpyrrolidone. As the thickener, one type or two or more types may be used.

As a method for producing the positive electrode for a lithium ion secondary battery, a known production method may be employed except that the cathode active material of the present invention is used. For example, as a method for producing the positive electrode for a lithium ion secondary battery, the following method may be mentioned.

The cathode active material, the electrically conductive material and the binder are dissolved or dispersed in a medium to obtain a slurry, or the cathode active material, the electrically conductive material and the binder are kneaded with a medium to obtain a kneaded product. Then, the obtained slurry or kneaded product is applied to the cathode current collector to form the cathode active material layer.

### [Lithium Ion Secondary Battery]

A lithium ion secondary battery has the positive electrode for a lithium ion secondary batter, a negative electrode and a non-aqueous electrolyte.

### [Negative Electrode]

The negative electrode contains at least an anode current collector and an anode active material layer.

As a material of the anode current collector, nickel, copper or stainless steel may, for example, be mentioned.

The anode active material layer at least contains an anode active material and as the case requires, contains a binder.

The anode active material may be any material so long as it is capable of absorbing and desorbing lithium ions. It may, for example, be a lithium metal, a lithium alloy, a lithium compound, a carbon material, a silicon carbide compound, a silicon oxide compound, a titanium sulfide, a boron carbide compound or an alloy composed mainly of silicon, tin or cobalt.

The carbon material to be used for the anode active material may, for example, be non-graphitized carbon, artificial graphite, natural graphite, thermally decomposed carbon, cokes, graphites, glassy carbons, an organic polymer compound fired product, carbon fibers, activated carbon or carbon blacks. The cokes may, for example, be pitch coke, needle coke or petroleum coke. The organic polymer compound fired product may be a product obtained by firing and carbonizing a phenol resin, a furan resin or the like at an appropriate temperature.

In addition, as the material capable of absorbing and desorbing lithium ions, for example, iron oxide, ruthenium oxide, molybdenum oxide, tungsten oxide, titanium oxide, tin oxide or Li_{2.6}Co_{0.4}N may also be used as the anode active material.

The binder may be the same as the binder mentioned for the cathode active material layer.

The anode may be obtained, for example, by mixing the anode active material with an organic solvent to prepare a slurry, and applying the prepared slurry to an anode current collector, followed by drying and pressing.

The non-aqueous electrolyte may, for example, be a non-aqueous electrolytic solution, an inorganic solid electrolyte, or a solid or gelled polymer electrolyte in which an electrolyte salt is mixed with or dissolved in e.g. a polymer compound.

The non-aqueous electrolytic solution may be one prepared by properly combining an organic solvent and an electrolyte salt.

The organic solvent contained in the non-aqueous electrolytic solution may, for example, be a cyclic carbonate, a chain carbonate, 1,2-dimethoxyethane, 1,2-diethoxyethane, diglyme, triglyme, γ-butyrolactone, diethyl ether, sulfolane, methyl sulfolane, acetonitrile, an acetic acid ester, a butyric acid ester or a propionic acid ester. The cyclic carbonate may, for example, be propylene carbonate or ethylene carbonate. The chain carbonate may, for example, be diethyl carbonate or dimethyl carbonate. Among them, in view of the voltage stability, preferred is the cyclic carbonate or the chain carbonate, more preferred is propylene carbonate, dimethyl carbonate or diethyl carbonate. They may be used alone or in combination of two or more.

The polymer compound to be used for the solid polymer electrolyte in which an electrolyte salt is mixed with or dissolved in the polymer compound, may, for example, be polyethylene oxide, polypropylene oxide, polyphosphazene, polyaziridine, polyethylene sulfide, polyvinyl alcohol, polyvinylidene fluoride, polyhexafluoropropylene or a derivative, mixer or composite thereof.

The polymer compound to be used for the gelled polymer electrolyte in which an electrolyte salt is mixed with or dissolved in the polymer compound may, for example, be a fluorinated polymer compound, polyacrylonitrile, a copolymer of polyacrylonitrile, polyethylene oxide or a copolymer of polyethylene oxide. The fluorinated polymer compound may, for example, be poly(vinylidene fluoride) or poly(vinylidene fluoride-co-hexafluoropropylene).

As a matrix of the gelled electrolyte, preferred is a fluorinated polymer compound from the viewpoint of the stability in the oxidation/reduction reaction.

The electrolyte salt may, for example, be LiClO₄, LiPF₆, LiBF₄, CF₃SO₃Li, LiCI or LiBr.

The inorganic solid electrolyte may, for example, be lithium nitride or lithium iodide.

The shape of the lithium ion secondary battery is not particularly limited and may, for example, be a coin-shape, a sheet-form (film-form), a folded shape, a wound cylinder with bottom, or a button shape, and is suitably selected depending upon the intended use.

### EXAMPLES

Now, the present invention will be described in further detail with reference to Examples. However, it should be understood that the present invention is by no means restricted thereto. Ex. 1 to 11 are Examples of the present invention, and Ex. 12 to 16 are Comparative Examples.

### [Specific Surface Area]

The specific surface area of each of the coprecipitate and the cathode active material was measured by a nitrogen adsorption BET (Brunauer, Emmett, Teller) method using a specific surface area measuring apparatus (apparatus name: HM model-1208, manufactured by Mountech Co., Ltd.). Deaeration was carried out at 105° C. for 30 minutes for the coprecipitate and at 200° C. for 20 minutes for the cathode active material.

To measure the specific surface area of the coprecipitate, the coprecipitate after dried at 120° C. for 15 hours was used.

### [Particle Size]

The coprecipitate or the cathode active material was sufficiently dispersed in water by ultrasonic treatment, and measured by a laser diffraction/scattering type particle size distribution measuring apparatus (apparatus name: MT-3300EX) manufactured by NIKKISO CO., LTD., was carried out and the frequency distribution and an accumulative volume distribution curve were obtained, whereby the volume-based particle size distribution was obtained. The particle sizes at points of 10%, 50% and 90% on the obtained accumulative volume distribution curve were taken as D₁₀, D₅₀ and D₉₀, respectively.

### [Aspect Ratio of Primary Particles]

The obtained cathode active material was observed with a scanning electron microscope (SEM), and in the obtained image, the longest size d1 of a primary particle and the maximum size d2 in a direction perpendicular to the direction along the longest size of the primary particle were obtained, and d1/d2 was taken as the aspect ratio. Measurement was conducted with respect to totally 100 primary particles randomly selected in the SEM image, and the aspect ratio was calculated as their average.

### [Average Particle Size of Primary Particle Corresponding to Circle]

The obtained cathode active material was observed with a SEM, and a primary particle in the SEM image was edged as shown in FIG. 1 and its area was obtained, and the diameter of a circle when the area of the primary particle was calculated as an area equivalent to a circle. The same measurement was carried out with respect to totally 100 primary particles, and from their average, the average value of the equivalent circle diameter of primary particles was calculated.

### [X-Ray Diffraction]

The X-ray diffraction of the cathode active material was measured by an X-ray diffraction apparatus (manufactured by Rigaku Corporation, apparatus name: SmartLab). The measurement conditions are shown in Table 1. The measurement was carried out at 25° C. With respect to the obtained X-ray diffraction pattern, peak search was carried out using integrated X-ray powder diffraction software PDXL2 manufactured by Rigaku Corporation, and the integrated intensity (I₀₂₀) of a peak of (020) plane assigned to a crystal structure with space group C2/m and the integrated intensity (I₀₀₃) of a peak of (003) plane assigned to a crystal structure with space group R-3m were obtained, and the ratio (I₀₂₀/I₀₀₃) was calculated.

TABLE 1

| Apparatus | Measurement | SmartLab manufactured by | |
|---|---|---|---|
| condition | apparatus | Rigaku Corporation | |
| | Target | Cu | |
| | Detector | D/teX Ultra HE manufactured | |
| | | by Rigaku Corporation | |
| | Detector baseline | 44 | div |
| | Detector window | 8 | div |
| | Gonio length | 300 | mm |
| | Soller/PSC | 5.0 | (deg.) |
| | IS long dimension | 10 | (mm) |
| | PSA | Open | |
| | Soller | 5.0 | (deg.) |
| | Monochromatization | Kβ filter method | |
| | method | | |
| Sample | Sample holder | Diameter: 24 mm, | |
| condition | | depth: 0.5 mm | |
| | Rotation of sample | Rotated (30 rpm) | |
| | during measurement | | |
| Measurement | Measurement | General purpose measurement | |
| condition | method | (focal method) | |
| | Scanning axis | 2θ/θ | |
| | Mode | Continuous | |
| | Range specification | Absolute | |
| | Initiation (deg.) | 10 | (deg.) |
| | Termination (deg.) | 90 | (deg.) |
| | Step (deg.) | 0.01 | (deg.) |
| | Speed measurement | 10 | (deg./min.) |
| | time | | |
| | IS (deg.) | 1/3 | (deg.) |
| | RS1 (mm) | 8 | (mm) |
| | RS2 (mm) | 13 | (mm) |
| | Attenuator | Open | |
| | Tube voltage (kV) | 45 | (kV) |
| | Tube current (mA) | 200 | (mA) |

| | | |
|---|---|---|
| Data | Analysis software | PDXL2 manufactured by |
| processing | | Rigaku Corporation |
| condition | Smoothing | Smoothing by B-Spline, |
| | | χ threshold: 1.50 |
| | Background removal | Fitting |
| | Kα2 removal | Intensity ratio: 0.4970 |
| | Peak search | Secondary differentiation |
| | | σ cut: 3.00 |
| | Profile fitting | Fitting of measurement data |
| | Peak shape | Variance pseudo-voigt function |

### [TEM Observation]

A cross section and an electron diffraction pattern of the cathode active material were observed by a transmission electron microscope (TEM, manufactured by Hitachi High-Technologies Corporation, apparatus name: H9000, accelerating voltage: 300 kV), and TEM (manufactured by JEOL Ltd., apparatus name: JEM-2010F, accelerating voltage: 200 kV). The cross section observation was carried out by observing a high resolution TEM image using an ultrathin section of the cathode active material embedded in an epoxy resin and cut by an ultramicrotome. Further, to obtain an electron diffraction pattern by the TEM, selected-area electron diffraction and nanometer area electron diffraction method were employed.

### [Composition Analysis]

The chemical composition of the cathode active material was analyzed by inductively-coupled plasma (ICP) spectrometry. From the obtained composition, a, α, β and γ in the formula (2) were calculated.

### [Evaluation Method]

### (Production of Cathode Sheet)

The cathode active material obtained in each Example, acetylene black as the electrically conductive material, and polyvinylidene fluoride (binder) were weighed in a mass ratio of 80:10:10 and added to N-methylpyrrolidone to prepare a slurry.

Then, the slurry was applied on one side of an aluminum foil (cathode current collector) having a thickness of 20 μm by means of a doctor blade. The gap of the doctor blade was adjusted so that the thickness of the cathode sheet after roll pressing would be 30 μm. After drying at 120° C., roll pressing was carried out twice to prepare a cathode sheet.

### (Production of Lithium Ion Secondary Battery)

Using as a positive electrode a circle having a diameter of 18 mm punched out from the obtained cathode sheet, a stainless steel simple sealed cell type lithium ion secondary battery was assembled in an argon glove box. As a negative electrode, a metal lithium foil having a thickness of 500 μm was formed on a stainless steel plate having a thickness of 1 mm as an anode current collector. As a separator, a porous polypropylene having a thickness of 25 μm was used. Further, as an electrolytic solution, a solution of LiPF₆ at a concentration of 1 mol/dm³ in a mixed solution of ethylene carbonate (EC) and diethyl carbonate (DEC) in a volume ratio of 1:1 was used.

### (Initial Discharge Capacity and Discharge Retention)

The lithium ion secondary battery was charged to 4.6 V with a load current of 20 mA per 1 g of the cathode active material at a constant current at a constant voltage of 4.6 V over a period of 23 hours and then discharged to 2.0 V with a load current of 20 mA per 1 g of the cathode active material.

Then, the lithium ion secondary battery was charged to 4.5 V with a load current of 200 mA per 1 g of the cathode active material and then discharged to 2.0 V with a load current of 200 mA per 1 g of the cathode active material. This charge and discharge cycle was repeated 100 times.

The discharge capacity in discharge after 4.6 V charge was taken as the initial discharge capacity. Further, the ratio of the discharge capacity in 100th 4.5 V charge based on the discharge capacity in the third 4.5 V charge was taken as the capacity retention (%).

### Ex. 1

Nickel(II) sulfate hexahydrate, cobalt(II) sulfate heptahydrate and manganese(II) sulfate pentahydrate were dissolved in distilled water so that the proportion of Ni, Co and Mn would be as shown in Table 2 and that the total concentration of Ni, Co and Mn would be 1.5 mol/L to obtain an aqueous sulfate solution. Ammonium sulfate was dissolved in distilled water to prepare a 0.75 mol/L aqueous ammonium sulfate solution.

Into a 2 L baffle-equipped glass reactor, distilled water was put and heated to 50° C. by a mantle heater, and the aqueous sulfate solution and the aqueous ammonium sulfate solution were added while the solution in the reactor was stirred by a two-stage tilt paddle type stirring blade. The rate of addition of the aqueous sulfate solution was 5.0 g/min. The aqueous ammonium sulfate solution was added so that the molar ratio (NH₄⁺/X) of ammonium ions based on the total amount of the transition metal elements (X) of Ni, Co and Mn in the reactor would be as shown in Table 2. Further, the initial pH of the reaction solution was 7.0, and a 48 mass % aqueous sodium hydroxide solution was added to keep the pH of the solution during the reaction of 11.0. The respective solutions were added over a period of 14 hours to precipitate a coprecipitate containing Ni, Co and Mn. Further, during the precipitation reaction, a nitrogen gas was made to flow through the reactor at a rate of 2 Umin so that the precipitated coprecipitate would not be oxidized.

The obtained coprecipitate was washed by repetition of pressure filtration and dispersion in distilled water to remove impurity ions. Washing was completed at a point where the electrical conductivity of the filtrate became less than 20 mS/m. The coprecipitate after washing was dried at 120° C. for 15 hours.

Then, the obtained coprecipitate and lithium carbonate were mixed so that the molar ratio (Li/X) of Li based on the total amount of the transition metal elements (X) of Ni, Co and Mn would be as shown in Table 2. The mixture was subjected to temporary firing in the air atmosphere at 600° C. for 5 hours and then main firing at 845° C. for 16 hours to obtain a cathode active material comprising a composite oxide.

### Ex. 2 to 11 and 14 to 16

A cathode active material was obtained in the same manner as in Ex. 1 except that the charge proportion of the sulfates, the reaction time (the time of addition of the aqueous sulfate solution), the pH of the reaction solution, the reaction temperature and the NH₄⁺/X and Li/X ratios were changed as identified in Table 2.

### Ex. 12

Nickel(II) sulfate hexahydrate, cobalt(II) sulfate heptahydrate and manganese(II) sulfate pentahydrate were dissolved in distilled water so that the proportion of Ni, Co and Mn would be as shown in Table 2 and that the total concentration of Ni, Co and Mn would be 1.5 mol/L to obtain an aqueous sulfate solution. Sodium carbonate was dissolved in distilled water to prepare a 1.5 mol/L aqueous carbonate solution.

Into a 2 L baffle-equipped glass reactor, distilled water was put and heated to 30° C. by a mantle heater, and the aqueous sulfate solution was added at a rate of 5.0 g/min over a period of 28 hours while the solution in the reactor was stirred by a two-stage tilt paddle type stirring blade, and the aqueous carbonate solution was added to keep the pH of the reaction solution of 8.0, to precipitate a coprecipitate containing Ni, Co and Mn.

The obtained coprecipitate was washed by repetition of pressure filtration and dispersion in distilled water to remove impurity ions. Washing was completed at a point where the electrical conductivity of the filtrate became less than 20 mS/m. The coprecipitate after washing was dried at 120° C. for 15 hours.

Then, the obtained coprecipitate and lithium carbonate were mixed so that Li/X would be as shown in Table 2, and the mixture was subjected to temporary firing in the air atmosphere at 600° C. for 5 hours and then main firing at 860° C. for 16 hours to obtain a cathode active material comprising a composite oxide.

### Ex. 13

A cathode active material was obtained in the same manner as in Ex. 1 except that during the precipitation reaction, the air was made to flow through the reactor at a rate of 2 L/min instead of the nitrogen gas, and temporary firing was not conducted.

The particle sizes (D₁₀, D₅₀ and D₉₀) and the specific surface area of the coprecipitate obtained in each Ex are shown in Table 3. Further, in FIG. 3, as representative examples of the X-ray diffraction pattern of the cathode active material, X-ray diffraction patterns of the cathode active materials in Ex. 1 and 16 are shown. I₀₀₃, I₀₂₀ and I₀₂₀/I₀₀₃ were calculated from the X-ray diffraction patterns of the cathode active materials obtained in the respective Ex. The particle sizes (D₁₀, D₅₀ and D₉₀), the specific surface area, the aspect ratio, the average value of the equivalent circle diameter, and analyzed values of a, α, β and γ when the lithium-containing composite oxide was represented by the formula (2), are shown in Table 3.

The results of measurement of the initial discharge capacity and the capacity retention of the lithium ion secondary battery using the cathode active material in each Ex. are shown in Table 4.

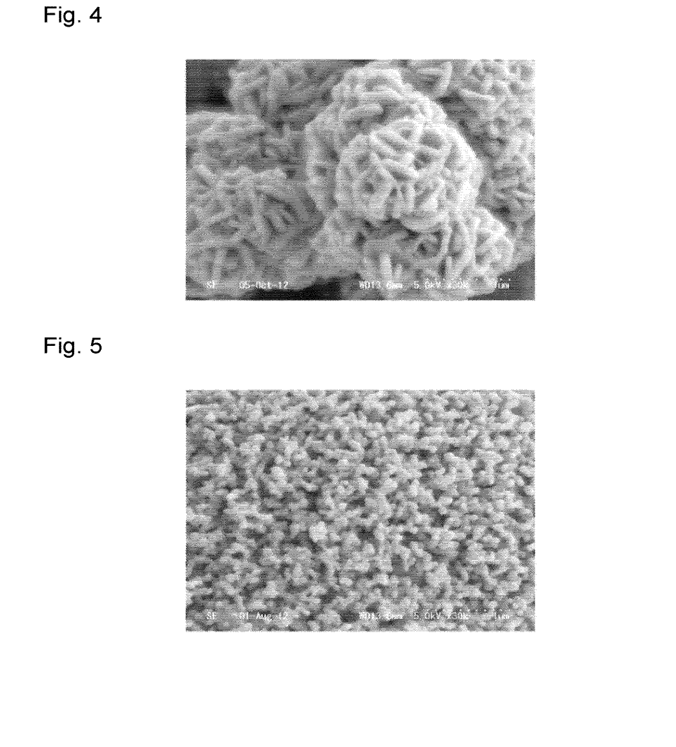

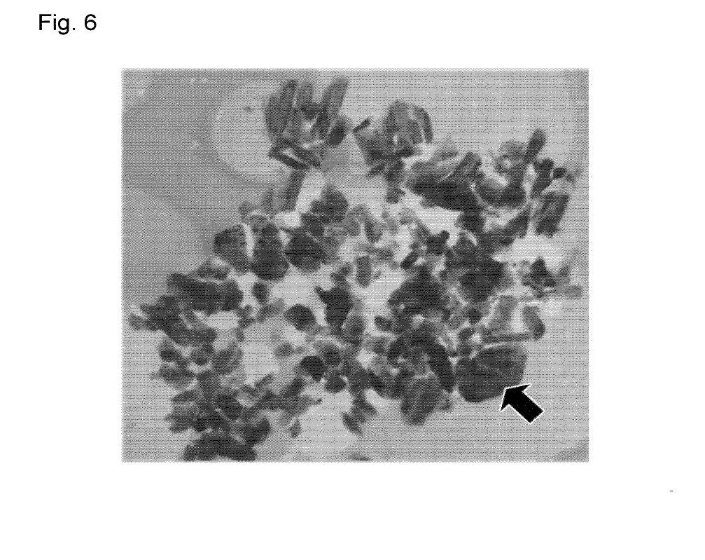

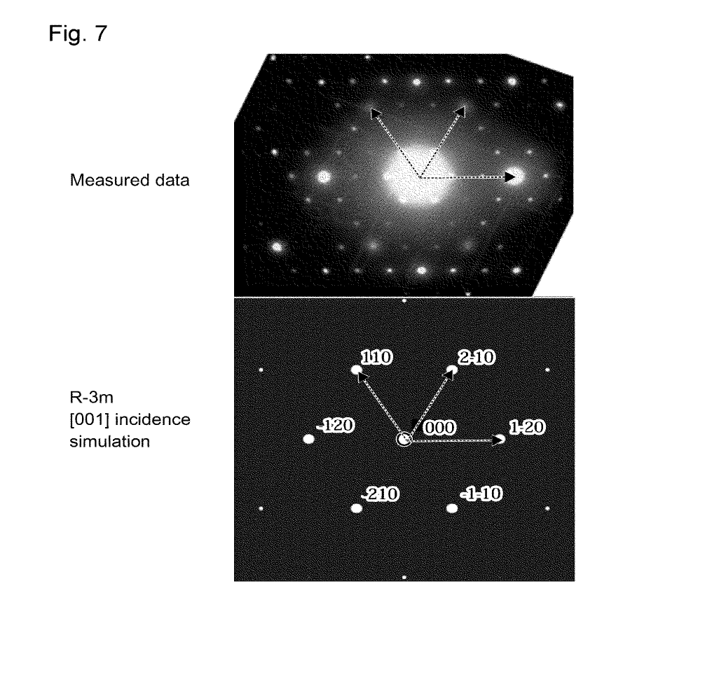

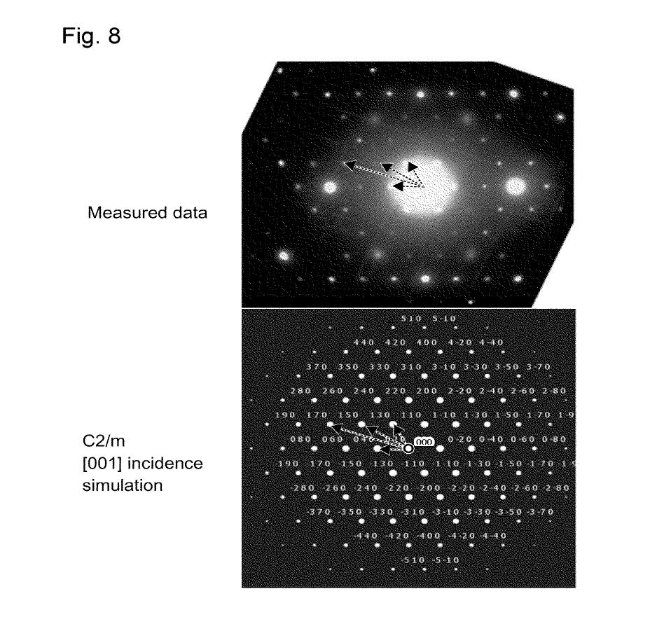

Further, a SEM image of the cathode active material in Ex. 1 is shown in FIG. 4, and a TEM image of the cross section is shown in FIG. 6. A comparison between an electron diffraction pattern of the primary particle indicated by the arrow in FIG. 6, and simulation of an electron diffraction pattern resulting from [001] incidence in a crystal structure with space group R-3m, is shown in FIG. 7. A comparison between an electron diffraction pattern of the primary particle indicated by the arrow in FIG. 6, and simulation of an electron diffraction pattern resulting from [001] incidence in a crystal structure with space group C2/m, is shown in FIG. 8. A SEM image of the cathode active material in Ex. 13 is shown in FIG. 5.

TABLE 2

| | Precipitation reaction conditions | | | | | | | | | Lithiation conditions | | | | |
|---|---|---|---|---|---|---|---|---|---|---|---|---|---|---|
| | Charge molar proportion | | | | Reac- | | | Reaction | | | Temporary firing | | Main firing | |
| | of sulfates | | | | tion | | Con- | temper- | | | Temper- | | Temper- | |
| | Ni | Co | Mn | | time | Initial | trolled | ature | NH₄⁺/X | | ature | Atmo- | ature | Atmo- |
| | [%] | [%] | [%] | Alkali | [hr.] | pH | pH | [° C.] | ratio | Li/X | [° C.] | sphere | [° C.] | sphere |
| Ex. 1 | 38.6 | 8.6 | 52.9 | NaOH | 14 | 7.0 | 11.0 | 50 | 0.10 | 1.18 | 600 | Air | 845 | Air |
| Ex. 2 | 38.6 | 8.6 | 52.9 | NaOH | 14 | 7.0 | 11.0 | 30 | 0.10 | 1.18 | Nil | Nil | 845 | Air |
| Ex. 3 | 38.6 | 8.6 | 52.9 | NaOH | 14 | 11.0 | 10.0 | 50 | 0.10 | 1.18 | Nil | NII | 845 | Air |
| Ex. 4 | 38.6 | 8.6 | 52.9 | NaOH | 28 | 7.0 | 11.0 | 50 | 0.10 | 1.17 | 600 | Air | 845 | Air |
| Ex. 5 | 34.6 | 0 | 65.4 | NaOH | 14 | 11.0 | 11.0 | 50 | 0.10 | 1.34 | 600 | Air | 845 | Air |
| Ex. 6 | 25.0 | 0 | 75.0 | NaOH | 14 | 11.0 | 11.0 | 50 | 0.10 | 1.54 | 600 | Air | 845 | Air |
| Ex. 7 | 20.0 | 15.0 | 65.0 | NaOH | 14 | 11.0 | 11.0 | 50 | 0.10 | 1.48 | 600 | Air | 845 | Air |
| Ex. 8 | 32.3 | 4.6 | 63.1 | NaOH | 14 | 11.0 | 11.0 | 50 | 0.10 | 1.34 | 600 | Air | 845 | Air |
| Ex. 9 | 42.9 | 0 | 57.1 | NaOH | 14 | 11.0 | 11.0 | 50 | 0.10 | 1.18 | 600 | Air | 845 | Air |
| Ex. 10 | 30.0 | 9.2 | 60.8 | NaOH | 14 | 11.0 | 11.0 | 50 | 0.10 | 1.34 | 600 | Air | 845 | Air |
| Ex. 11 | 27.7 | 13.8 | 58.5 | NaOH | 14 | 11.0 | 11.0 | 50 | 0.10 | 1.34 | 600 | Air | 845 | Air |
| Ex. 12 | 38.6 | 8.6 | 52.9 | Na₂CO₃ | 28 | 10.0 | 8.0 | 30 | 0 | 1.15 | 600 | Air | 860 | Air |
| Ex. 13 | 38.6 | 8.6 | 52.9 | NaOH | 14 | 7.0 | 11.0 | 50 | 0.10 | 1.18 | Nil | Nil | 845 | Air |
| Ex. 14 | 38.6 | 8.6 | 52.9 | NaOH | 14 | 12.0 | 12.0 | 50 | 0.10 | 1.18 | Nil | Nil | 845 | Air |
| Ex. 15 | 38.6 | 8.6 | 52.9 | NaOH | 14 | 7.0 | 11.0 | 70 | 0.10 | 1.18 | Nil | Nil | 845 | Air |
| Ex. 16 | 13.6 | 0 | 86.4 | NaOH | 14 | 11.0 | 11.0 | 50 | 0.10 | 1.76 | 600 | Air | 845 | Air |

TABLE 3

| | | | | | Cathode active material | | | | | | | | | | | | |
|---|---|---|---|---|---|---|---|---|---|---|---|---|---|---|---|---|---|
| | | | | | | | | | | | | | | | Average | Spe- | |
| | Coprecipitate | | | | | | | | | | | | | | value of | cific | |
| | | | | Specific | | | | | | | | | | | equivalent | sur- | |
| | Particle size | | | surface | | | | | I₀₀₃ | I₀₂₀ | | Particle size | | | circle | face | Aspect |
| | [μm] | | | area | Analytical composition | | | | [cps · | [cps · | I₀₂₀/ | [μm] | | | diameter | area | ratio |
| | D₁₀ | D₅₀ | D₉₀ | [m²/g] | a | α | β | γ | deg] | deg] | I₀₀₃ | D₁₀ | D₅₀ | D₉₀ | [nm] | [m²/g] | (d1/d2) |
| Ex. 1 | 2.1 | 3.3 | 4.9 | 27.4 | 0.25 | 0.47 | 0.10 | 0.43 | 58953 | 1621 | 0.03 | 3.0 | 4.4 | 6.9 | 212 | 4.0 | 3.18 |
| Ex. 2 | 3.5 | 6.0 | 9.9 | 17.4 | 0.25 | 0.47 | 0.10 | 0.43 | 57758 | 2233 | 0.04 | 3.9 | 5.9 | 9.3 | 372 | 3.4 | — |
| Ex. 3 | 6.5 | 9.0 | 13.1 | 16.9 | 0.25 | 0.47 | 0.10 | 0.42 | 55986 | 4047 | 0.07 | 6.4 | 8.6 | 12.4 | 292 | 3.1 | 3.35 |
| Ex. 4 | 3.8 | 5.8 | 9.1 | 16.1 | 0.24 | 0.47 | 0.10 | 0.43 | 83659 | 2840 | 0.03 | 4.1 | 5.9 | 9.0 | 343 | 2.1 | 2.68 |
| Ex. 5 | 2.7 | 3.9 | 5.7 | 28.0 | 0.44 | 0.53 | 0 | 0.47 | 79781 | 8393 | 0.11 | 2.9 | 3.8 | 5.4 | 253 | 3.8 | 3.19 |
| Ex. 6 | 3.0 | 4.7 | 6.9 | 37.1 | 0.63 | 0.54 | 0 | 0.46 | 70635 | 11232 | 0.16 | 3.5 | 4.7 | 6.9 | 340 | 4.1 | 3.85 |
| Ex. 7 | 3.5 | 5.2 | 7.7 | 38.9 | 0.58 | 0.39 | 0.29 | 0.32 | 73842 | 9655 | 0.13 | 3.8 | 5.3 | 7.9 | — | 4.7 | — |
| Ex. 8 | 2.7 | 4.1 | 6.3 | 28.3 | 0.44 | 0.49 | 0.07 | 0.44 | 79971 | 6675 | 0.08 | 3.2 | 4.6 | 7.1 | 250 | 3.9 | 2.84 |
| Ex. 9 | 2.1 | 3.6 | 5.5 | 33.4 | 0.25 | 0.52 | 0 | 0.48 | 85748 | 3524 | 0.04 | 2.9 | 4.2 | 6.4 | 235 | 5.0 | 3.04 |
| Ex. 10 | 2.1 | 3.6 | 5.4 | 27.8 | 0.44 | 0.46 | 0.14 | 0.40 | 80244 | 6086 | 0.08 | 3.0 | 4.2 | 6.4 | 280 | 4.3 | 3.30 |
| Ex. 11 | 2.8 | 4.1 | 6.1 | 30.5 | 0.44 | 0.42 | 0.21 | 0.37 | 79070 | 4366 | 0.06 | 3.1 | 4.5 | 7.0 | 299 | 4.2 | 3.05 |
| Ex. 12 | 6.3 | 10.4 | 16.4 | 208.0 | 0.20 | 0.45 | 0.10 | 0.45 | 58801 | 2347 | 0.04 | 6.2 | 9.5 | 14.5 | 122 | 6.8 | 1.38 |
| Ex. 13 | 4.4 | 6.0 | 8.7 | 115.9 | 0.25 | 0.47 | 0.10 | 0.43 | 57878 | 2008 | 0.03 | 2.9 | 3.8 | 5.4 | 158 | 7.3 | 1.99 |
| Ex. 14 | 1.1 | 1.8 | 3.1 | 64.4 | 0.25 | 0.47 | 0.10 | 0.43 | 60664 | 2298 | 0.04 | 1.8 | 4.0 | 29.6 | 156 | 9.2 | 1.98 |
| Ex. 15 | 1.7 | 3.0 | 4.8 | 57.2 | 0.25 | 0.47 | 0.10 | 0.43 | 59510 | 1565 | 0.03 | 2.2 | 3.6 | 6.0 | 186 | 7.9 | 2.12 |
| Ex. 16 | 5.3 | 7.3 | 10.7 | 46.7 | 0.83 | 0.58 | 0 | 0.42 | 68159 | 21879 | 0.32 | 4.1 | 6.1 | 9.7 | 181 | 5.5 | 1.54 |

TABLE 4

| | Initial discharge | Capacity |
|---|---|---|
| | capacity | retention |
| | [mAh/g] | [%] |
| Ex. 1 | 227.7 | 91.4 |
| Ex. 2 | 221.0 | 94.0 |
| Ex. 3 | 214.8 | 89.8 |
| Ex. 4 | 218.7 | 97.3 |
| Ex. 5 | 261.5 | 92.7 |
| Ex. 6 | 252.4 | 83.3 |
| Ex. 7 | 275.9 | 79.3 |
| Ex. 8 | 260.7 | 91.6 |
| Ex. 9 | 232.2 | 93.3 |
| Ex. 10 | 253.6 | 87.8 |
| Ex. 11 | 247.9 | 88.6 |
| Ex. 12 | 229.7 | 57.1 |
| Ex. 13 | 231.1 | 60.4 |
| Ex. 14 | 228.4 | 38.0 |
| Ex. 15 | 226.6 | 62.0 |
| Ex. 16 | 176.9 | 31.3 |

As shown in Tables 3 and 4, in Ex. 1 to 11, the aspect ratio is from 2.5 to 10 and I₀₂₀/I₀₀₃ is from 0.02 to 0.3. With such a Li rich cathode active material, a high discharge capacity was obtained. Whereas in Ex. 12 to 16 in which one or more of the aspect ratio and I₀₂₀/I₀₀₃ was not satisfied, the capacity retention was low, and sufficient cycle durability was not exhibited. It is evident from FIGS. 4 and 5 that particles having an aspect ratio of from 2.5 to 10 are in a plate form and undergo anisotropic growth (FIG. 4), and particles having a low aspect ratio undergo isotropic growth (FIG. 5).

The structure of the cathode active material in Ex. 1 as a representative example was studied and as a result, as shown in FIG. 6, the cross section shape of the primary particles in the cross section of the cathode active material in Ex. 1 was roughly classified into rod shape and a substantially circular shape closer to a circle.

An electron diffraction pattern of the primary particle observed in a substantially circular shape, indicated by the arrow in FIG. 6, was obtained. As shown in FIG. 7, the electron diffraction pattern well agreed with a simulated electron diffraction pattern resulting from [001] incidence in a crystal structure with space group R-3m. Further, as shown in FIG. 8, the electron diffraction pattern well agreed with a simulated electron diffraction pattern resulting from [001] incidence in a crystal structure with space group C2/m. It was confirmed from these results that the plane of the primary particle observed in a substantially circular shape in FIG. 6 was (001) plane in parallel with the a axis and the b axis of the crystallite.

Further, with respect to a primary particle observed in a rod shape in FIG. 6, a lattice fringe corresponding to a distance of (003) plane in a major axis direction of the primary particle was observed. Further, electron diffraction patterns which well agreed with a simulated electron diffraction pattern resulting from [100] incidence in a crystal structure with space group R-3m and a simulated electron diffraction pattern resulting from [100] incidence in a crystal structure with space group C2/m, were obtained (not shown). It was confirmed from these results that the plane of the primary particle observed in a rod shape in FIG. 6 was (003) plane perpendicular to the c axis of the crystallite.

It is considered from the above results that the primary particle observed in a rod shape in FIG. 6 and the primary particle observed in a substantially circular shape are in a relation to form an angle of 90° around the b axis as the center. Further, it was confirmed that the primary particles of the cathode active material in Ex. 1 were in a plate shape, their plane direction is the a-b axis direction, their thickness direction is the c axis direction, and (003) plane assigned to a crystal structure with space group R-3m was exposed to one side surface of the primary particles. It is considered that by the primary particles having such a special structure, the damages to the crystal structure by absorption and desorption of Li is suppressed, and favorable cycle durability is obtained.

### INDUSTRIAL APPLICABILITY

The cathode active material of the present invention is suitably used for a lithium ion secondary battery since it can achieve a high discharge capacity and favorable cycle durability.

This application is a continuation of PCT Application No. PCT/JP2014/064000, filed on May 27, 2014, which is based upon and claims the benefit of priority from Japanese Patent Application No. 2013-112126 filed on May 28, 2013. The contents of those applications are incorporated herein by reference in their entireties.

What is claimed is:

1. A cathode active material, which comprises a lithium-containing composite oxide containing at least one transition metal element (X) selected from the group consisting of Ni element, Co element and Mn element, and Li element (provided that the molar ratio (Li/X) of the Li element based on the total amount of the transition metal element (X) is from 1.1 to 1.7),
wherein the aspect ratio of primary particles is from 2.5 to 10, and
in an X-ray diffraction pattern, the ratio (I₀₂₀/I₀₀₃) of the integrated intensity (Ion) of a peak of (020) plane assigned to a crystal structure with space group C2/m to the integrated intensity (I₀₀₃) of a peak of (003) plane assigned to a crystal structure with space group R-3m is from 0.02 to 0.3.

2. The cathode active material according to claim 1, which is a solid-solution of Li_{4/3}Mn_{2/3}O₂ and LiMO₂ (wherein M is at least one transition metal element selected from the group consisting of Ni element, Co element and Mn element).

3. The cathode active material according to claim 2, wherein the solid-solution is represented by the following formula (1):
aLi_{4/3}Mn_{2/3}O₂.(1−a)LiMO₂ (1)
wherein M is at least one transition metal element selected from the group consisting of Ni element, Co element and Mn element, and “a” is from 0.1 to 0.78.

4. The cathode active material according to claim 1, wherein the molar proportion of Ni element is from 15 to 50%, the molar proportion of Co element is from 0 to 33.3%, and the molar proportion of Mn element is from 33.3 to 85% based on the total amount of the at least one transition metal element (X) selected from the group consisting of Ni element, Co element and Mn element.

5. The cathode active material according to claim 2, wherein the solid-solution is represented by the following formula (2):
aLi_{4/3}Mn_{2/3}O₂.(1−a)LiNi_{α}Co_{β}Mn_{γ}O₂ (2)
wherein α is from 0.33 to 0.55, β is from 0 to 0.33, and γ is from 0.30 to 0.5, provided that α+β+γ=1, and “a” is from 0.1 to 0.78.

6. The cathode active material according to claim 1, wherein the cathode active material has a particle size D₅₀ of 3 to 15 μm.

7. The cathode active material according to claim 1, wherein the cathode active material has a ratio D₉₀/D₁₀ of the particle size D₉₀ to the particle size D₁₀ of 1 to 2.6.

8. The cathode active material according to claim 1, wherein the cathode active material has a specific surface area of 0.1 to 10 m²/g.

9. The cathode active material according to claim 1, wherein primary particles have an average value of the equivalent circle diameter of 10 to 1,000 nm.

10. The cathode active material according to claim 1, wherein primary particles have an average value of the equivalent circle diameter of 200 to 700 nm.
